(19) United States
(12) Patent Application Publication
(10) Pub. No.: US 2013/0177267 A1
(43) Pub. Date: Jul. 11, 2013

(54) LINEAR SLIDING BLOCK HAVING ROLLING BALL RETAINER

(71) Applicant: Kuo-Le Tsao, New Taipei City (TW)

(72) Inventor: Kuo-Le Tsao, New Taipei City (TW)

(21) Appl. No.: 13/436,975

(22) Filed: Apr. 1, 2012

(30) Foreign Application Priority Data
Jan. 5, 2012 (TW) 101200223

(51) Int. Cl. F16C 29/06

(52) U.S. Cl. 384/43

(57) ABSTRACT

A linear sliding block having a rolling ball retainer includes a base block, two circulation-guiding blocks, a plurality of rolling balls and two retainers. The base block has a sliding groove corresponding to a linear sliding rail and at least a pair of load-bearing tracks at two sides of the sliding groove. The two circulation-guiding blocks are coupled to two ends of the base block. The rolling balls are received in load-bearing tracks and non-load tracks. Each retainer has a strip corresponding in position to the load-bearing tracks to hold the rolling balls. The strip has a pair of fixing pieces at two ends thereof. The fixing pieces at the two ends of the strip are connected to the circulation-guiding blocks at the two ends of the base block with fixing members.

### CROSS REFERENCE TO RELATED APPLICATIONS

This application is based upon and claims the benefit of priority from the prior Taiwan Patent Application No. 101200223, filed on Jan. 5, 2012, the entire contents of which are incorporated herein by reference.

### BACKGROUND OF THE INVENTION

(a) Field of the Invention

The present invention relates to a linear sliding block, and more particularly to a linear sliding block having a rolling ball retainer applied to a sliding rail.

(b) Description of the Prior Art:

A conventional linear sliding block is provided with a rolling ball retainer to hold rolling balls. The retainer is in the form of a chain or a steel wire. The retainer in the form of a chain is made of plastic, which cannot bend for a long period of time and may break easily. The retainer in the form of a chain is applied to a mini linear sliding block to result in difficult assembly and high cost.

The retainer in the form of a steel wire, as shown in FIG. 1 and FIG. 2, is made of a metallic wire to constitute a rolling ball retainer 10. The rolling ball retainer 10 is disposed at two sides of a sliding groove 201 of a linear sliding block 20 and corresponding in position to load-bearing tracks 202, so that the rolling balls 30 in the load-bearing tracks 202 are confined to prevent the rolling balls 30 from dropping. This type of retainer only limits the rolling balls 30 in the load-bearing tracks 202. The steel wire cannot be tightened to hold all of the rolling balls 30. When there is a shake, the rolling balls 30 may drop easily. FIG. 3 shows the configuration of the retainer in the form of a steel wire. The conventional linear sliding rail 40 is formed with a semi-circle recess 401 by secondary process. The recess 401 may communicate with a screw hole to form a broken hole. Accordingly, the inventor of the present invention has devoted himself based on his many years of practical experiences to solve these problems.

### SUMMARY OF THE INVENTION

The primary object of the present invention is to provide a linear sliding block having a rolling ball retainer. The rolling ball retainer has a strip. The strip has a pair of fixing pieces at two ends thereof. When the fixing pieces of the strip are locked to the circulation-guiding blocks, the strip is tightened to hold rolling balls stably. Even linear the sliding block is shaken, the rolling ball won't drop.

A further object of the present invention is to provide a linear sliding block having a rolling ball retainer. Guide tracks and rectangular recesses of a linear sliding rail are formed by cold drawing, not by secondary process, to save manpower and material resource. In this way, the cost can be lowered.

Another object of the present invention is to provide a linear sliding block having a rolling ball retainer. By the innovated design of the rolling ball retainer, there is no need for secondary process to form the recess, so the recess won't communicate with the screw hole to cause a broken hole.

### BRIEF DESCRIPTION OF THE DRAWINGS

FIG. 1 is an exploded view showing a conventional linear sliding block and rolling ball retainers;

FIG. 2 is a sectional view showing the conventional linear sliding block and rolling ball retainers;

FIG. 3 is a sectional view showing the conventional linear sliding block with broken holes caused by secondary process;

FIG. 4 is a perspective view showing the linear sliding block according to a preferred embodiment of the present invention;

FIG. 5 is an exploded view showing the linear sliding block according to the preferred embodiment of the present invention;

FIG. 6 is another exploded view showing the linear sliding block according to the preferred embodiment of the present invention;

FIG. 7 is a perspective sectional view showing the linear sliding block according to the preferred embodiment of the present invention;

FIG. 8 is a longitudinal sectional view showing the linear sliding block according to the preferred embodiment of the present invention; and

FIG. 9 is a transverse sectional view showing the linear sliding block according to the preferred embodiment of the present invention.

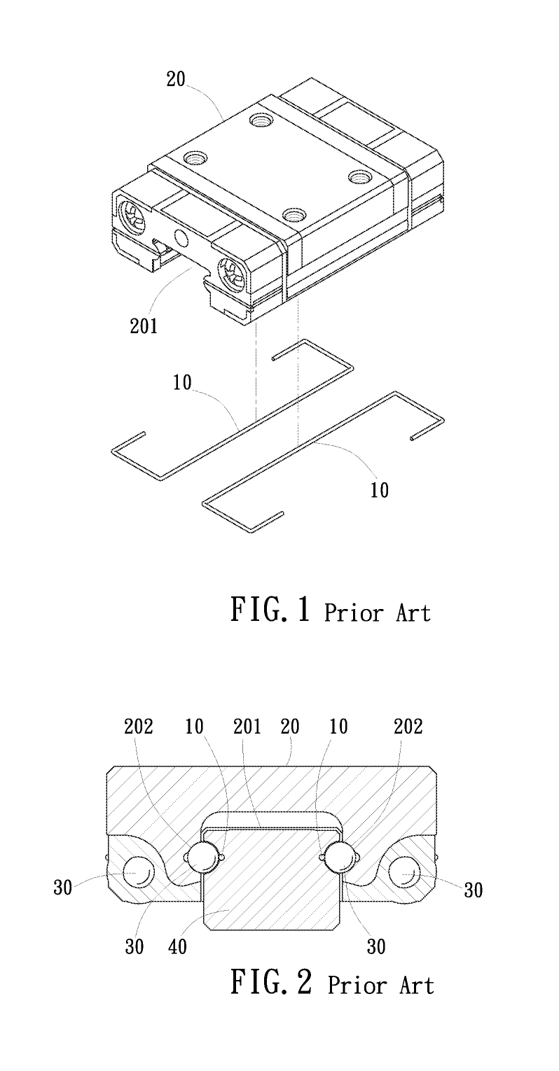

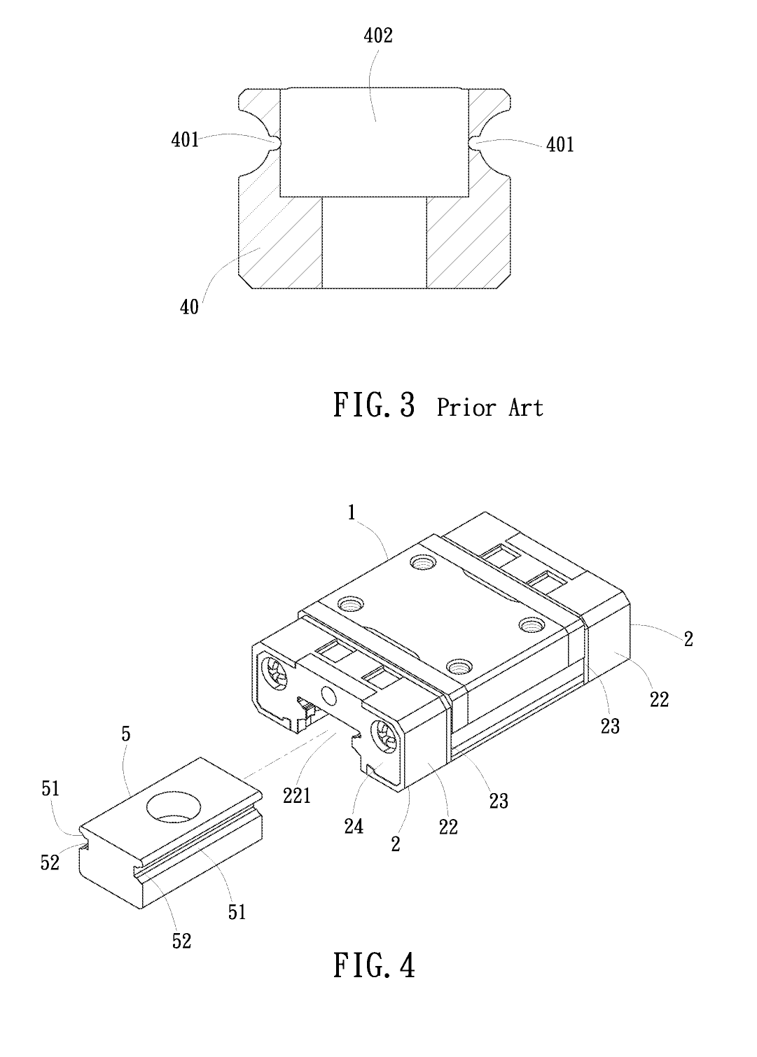

### DETAILED DESCRIPTION OF THE PREFERRED EMBODIMENTS

Embodiments of the present invention will now be described, by way of example only, with reference to the accompanying drawings.

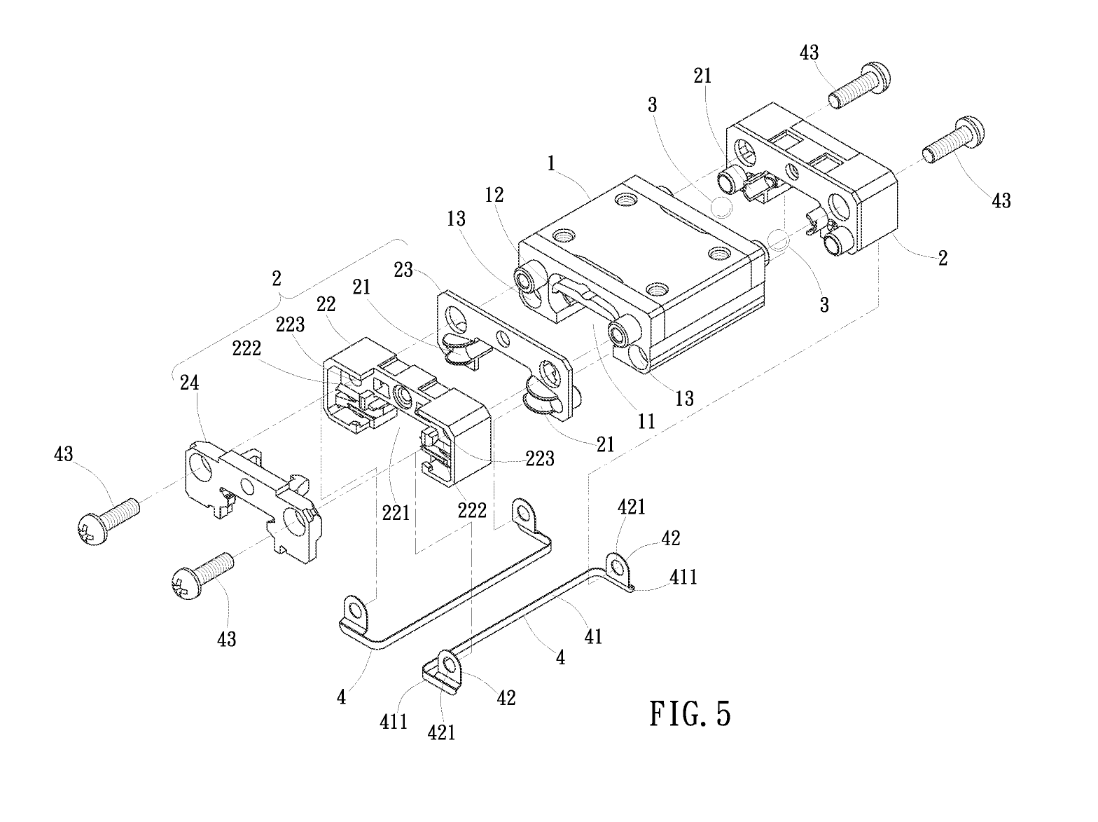

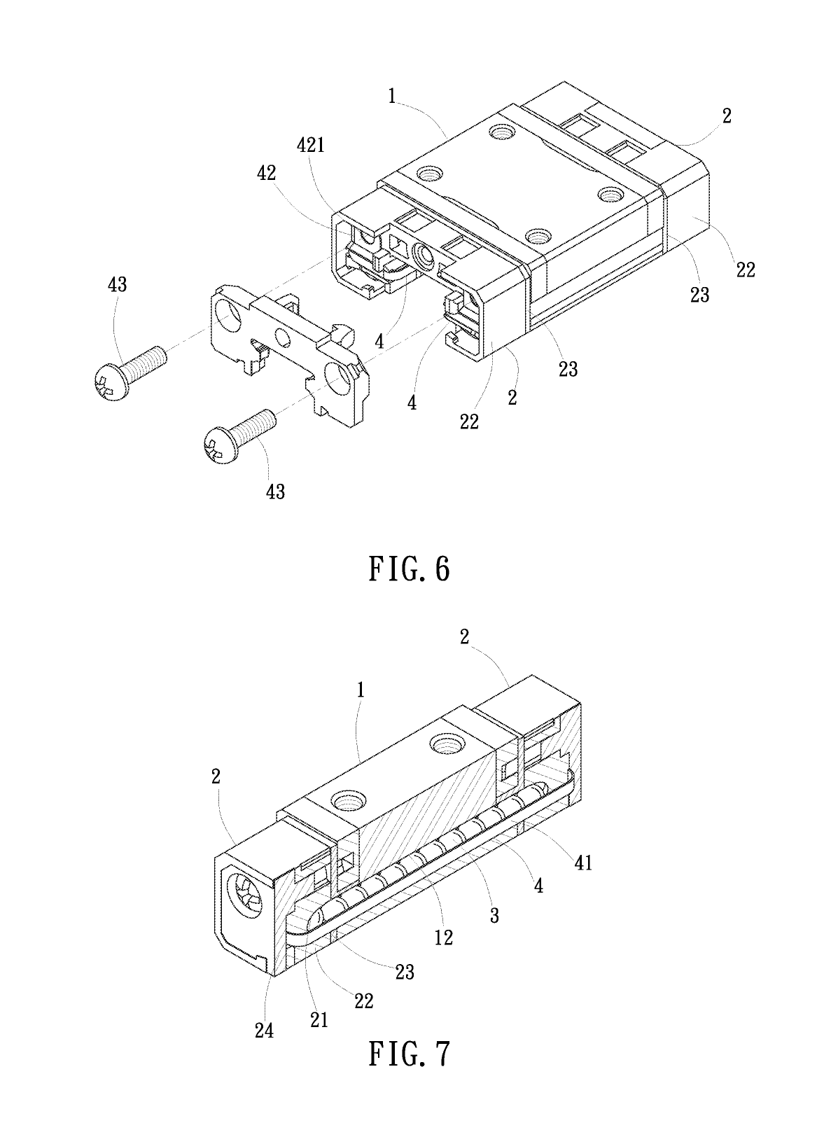

As shown in FIG. 4, FIG. 5 and FIG. 6, the linear sliding block having a rolling ball retainer according to a preferred embodiment of the present invention comprises a base block 1, two circulation-guiding blocks 2, a plurality of rolling balls 3, and two retainers 4. The linear sliding block is slidably mounted on a linear sliding rail 5 to slide thereon.

The base block 1 is a rectangular block or any type of block. The base block 1 has a sliding groove 11 corresponding to the linear sliding rail 5 at a bottom thereof and at least a pair of load-bearing tracks 12 at two sides of the sliding groove 11. The sliding groove 11 and the load-bearing tracks 12 extend to two ends of the base block 1. The base block 1 has a pair of non-load tracks 13 at two sides thereof. The non-load tracks 13 communicate with the two ends of the base block 11.

The two circulation-guiding blocks 2 are coupled to the two ends of the base block 1. Each of the two circulation-guiding blocks 2 has a pair of circulation tracks 21 to communicate the load-bearing tracks 12 and the non-load tracks 13.

The plurality of rolling balls 3 are received in the load-bearing tracks 12 and the non-load tracks 13 of the base block 1 and the circulation tracks 21 of each circulation-guiding block 2. When the linear sliding block moves along the linear sliding rail 5, the rolling balls 3 will run in the load-bearing tracks 12, the non-load tracks 13 and the circulation tracks 21 in circles. When the rolling balls 3 are in the load-bearing tracks 12, the rolling balls 3 will be contact with the linear sliding rail 5 as shown in FIG. 9 so that the linear sliding block can slide on the linear sliding rail 5 smoothly.

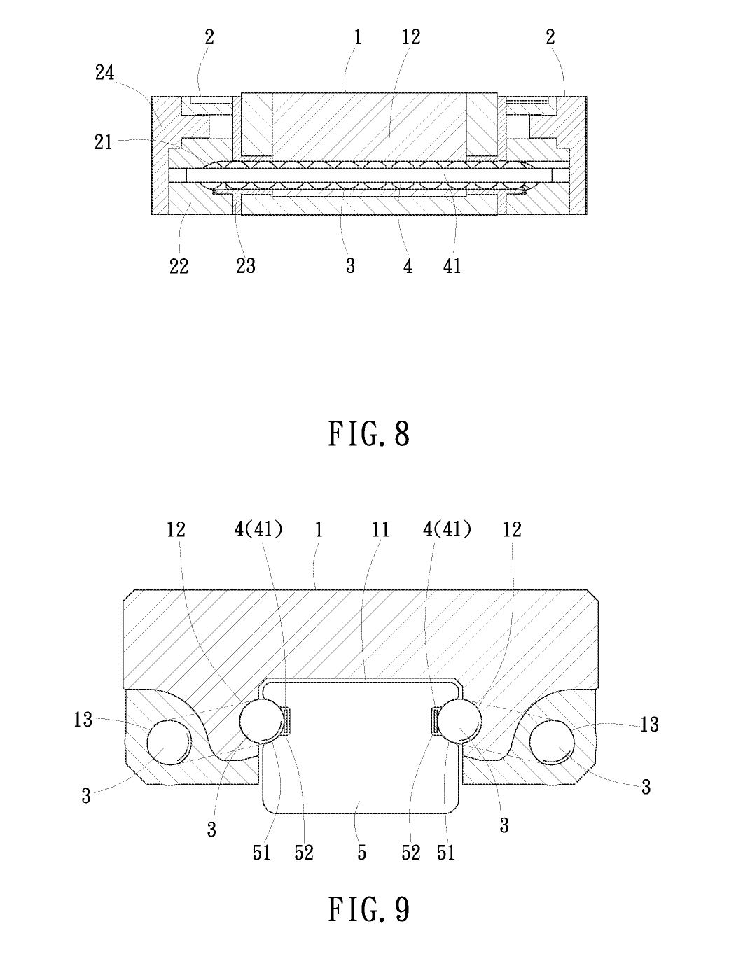

Referring to FIG. 6, FIG. 7 and FIG. 8, each of the retainers 4 has a strip 41 corresponding in position to the load-bearing tracks 12 to hold the plurality of rolling balls 3. The strip 41 can be made of metal, plastic or other material. The rolling balls 3 in the load-bearing tracks 12 are against one surface of the strip 41. The strip 41 has a pair of fixing pieces 42 at two ends thereof. The fixing pieces 42 at the two ends of the strip 41 are connected to the circulation-guiding blocks 2 at the two ends of the base block 1 with fixing members 43. Thus, the linear sliding block with a rolling ball retainer of the present invention is assembled.

Referring to FIG. 6 through FIG. 8, the two ends of the strip 41 of each retainer 4 have a pair of bent portions 411, so that the retainer 4 (the strip 41) has a U shape. The fixing pieces 42 are formed at the bent portions 411. Each of the fixing pieces 42 has a through hole 421 for insertion of the fixing members 43, such as screws, such that the retainers 4 are secured to the circulation-guiding blocks 2. The fixing pieces 42 and the bent portions 411 may be at different levels or at the same lever. Each of the circulation-guiding blocks 2 has a concaved stepped portion 222. When the fixing pieces 42 are connected to the circulation-guiding block 2, the depth of the concaved stepped portion 2222 is larger than the differential height between the fixing pieces 42 and the bent portions 411. When the fixing members 43 are inserted through the through holes 421 and locked to the circulation-guiding blocks 2, the locking operation of the fixing members 43 will push the fixing pieces 42 downward to pull the strip 41. The strip 41 is tightened to prevent the rolling balls 3 from dropping.

Referring to FIG. 5 and FIG. 6, each of the circulation-guiding blocks 2 comprises a first body 22, a second body 23 and an end cap 24. The first body 22 is formed by plastic injection molding. The first body 22 has a first passage 221 corresponding to the sliding grove 11. The first body 22 has a pair of concave stepped portions 222 at one side thereof not facing the base block 1. The concave stepped portions 22 correspond in position to the fixing pieces 42. The concave stepped portions 222 have fixing holes 223 for engagement of the fixing members 43. When the fixing pieces 42 at the two ends of the retainer 4 are connected to the concave stepped portions 222 by the fixing members 43, the strip 41 will be tightened to hold the rolling balls 3 in the load-bearing tracks 12 stably so that the rolling balls 3 won't disengage from the load-bearing tracks 12. The second body 23 is connected between the first body 22 and the base block 1 to form the circulation tracks 21. The end cap 24 covers the side having the fixing holes 223 of the first body 22 and is secured by the fixing members 43 (screws).

Referring to FIG. 9, for the retainer 4 not to interfere with the linear sliding rail 5, the linear sliding rail 5 has a pair of guide tracks 51 at two sides thereof. The guide tracks 51 have rectangular recesses 52 corresponding to the retainers 4. When the linear sliding block is slidably mounted on the linear sliding rail 5, the rectangular recesses 52 are adapted to accommodate the retainers 4. It is noted that the shape of the retainers 4 can be improved, and the guide tracks 51 and the rectangular recesses 52 of the linear sliding rail 5 are formed by cold drawing, not by secondary process. In this way, the cost can be lowered, and the broken hole caused by secondary process can be overcome.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A linear sliding block having a rolling ball retainer slidably mounted on a linear sliding rail, comprising a base block, two circulation-guiding blocks, a plurality of rolling balls and two retainers;
the base block having a sliding groove corresponding to the linear sliding rail and at least a pair of load-bearing tracks at two sides of the sliding groove, the sliding groove and the load-bearing tracks extending to two ends of the base block, the base block having a pair of non-load tracks at two sides thereof, the non-load tracks communicating with the two ends of the base block;
the two circulation-guiding blocks being coupled to the two ends of the base block, each of the two circulation-guiding blocks having a pair of circulation tracks to communicate the load-bearing tracks and the non-load tracks;
the plurality of rolling balls being received in the load-bearing tracks and the non-load tracks of the base block and the circulation tracks of each circulation-guiding block;
each of the retainers having a strip corresponding in position to the load-bearing tracks to hold the plurality of rolling balls, the rolling balls in the load-bearing tracks being against one side of the strip, the strip having a pair of fixing pieces at two ends thereof, the fixing pieces at the two ends of the strip being connected to the circulation-guiding blocks at the two ends of the base block with fixing members.

2. The linear sliding block having a rolling ball retainer as claimed in claim 1, wherein the two ends of the strip of each of the retainers have a pair of bent portions, each of the retainers has a U shape, and the fixing pieces are formed at the bent portions.

3. The linear sliding block having a rolling ball retainer as claimed in claim 2, wherein the fixing pieces and the bent portions are at different levels.

4. The linear sliding block having a rolling ball retainer as claimed in claim 3, wherein each of the fixing pieces has a through hole for insertion of the fixing members, such that the retainers are secured to the circulation-guiding blocks.

5. The linear sliding block having a rolling ball retainer as claimed in claim 1, wherein each of the circulation-guiding blocks comprises a first body, a second body and an end cap, the first body having a first passage corresponding to the sliding grove, the first body having a pair of concave stepped portions at one side thereof not facing the base block, the concave stepped portions corresponding in position to the fixing pieces, the concave stepped portions having fixing holes for engagement of the fixing members, the second body being connected between the first body and the base block, the end cap covering the side having the fixing holes of the first body.

6. The linear sliding block having a rolling ball retainer as claimed in claim 1, wherein the fixing members are screws.

7. The linear sliding block having a rolling ball retainer as claimed in claim 1, wherein the linear sliding rail has a pair of guide tracks at two sides thereof, and the guide tracks have rectangular recesses corresponding to the retainers.
